(19) United States
(12) Patent Application Publication
(10) Pub. No.: US 2006/0114820 A1
(43) Pub. Date: Jun. 1, 2006

(54) System and method for caching and fetching data

(75) Inventors: Neil E.J. Hunt, Waterloo (CA); Curtis A.P. Krawchuk, Waterloo (CA); William E. Wallace, Waterloo (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(73) Assignee: AGFA INC.

(21) Appl. No.: 10/996,359

(22) Filed: Nov. 26, 2004

(51) Int. Cl. H04J 3/14; H04J 1/16; H04L 1/00; H04L 12/26; H04L 12/56; H04L 12/28

(52) U.S. Cl. 370/229

(57) ABSTRACT

There is disclosed a data processing system and method for fetching a plurality of data frames for processing in succession at a desired rate. Data frames are fetched into available space in cache. A priority level is then assigned to each data frame by applying a recurring priority level pattern. A suitable priority level cut-off may be selected (e.g. based on available space in cache) and any data frames with a priority level below the priority level cut-off are dropped. Successive data frames having assigned priority levels above the priority level cut-off are selectively fetched into cache.

### BACKGROUND

The present invention relates generally to data processing systems, and more particularly to a system and method for caching and fetching data.

In data processing systems, in order to make efficient use of available data processing resources, it is often necessary to provide a data buffer between higher bandwidth and lower bandwidth components. For example, a cache is often used as a data buffer between a processor and large capacity storage (e.g. a disk drive) to temporarily store data that must be accessed very quickly for processing.

However, due to cost and design constraints, cache is often limited in size. If there is insufficient space available in cache, data must be dropped from cache, and new data must be fetched into cache in order to maintain a sufficient data buffer. If a poor data caching and fetching strategy is implemented, the resulting high input/output (I/O) generated by constantly dropping and fetching data may result in poor system performance. The problem may be worsened when the size of data that must be constantly dropped and fetched is large, or when the desired rate at which the data must be processed is high.

By way of example, in digital medical imaging applications (ultrasound, radiology, cardiology, etc.), high-resolution images are often necessary to facilitate proper diagnosis of a medical condition. In digital ultrasound, for example, many frames of high-resolution digital images are processed in rapid succession to produce a moving image. For just 30 seconds of ultrasound, comprising 900 high-resolution frames rendered at 30 frames per second, approximately 1.2 Gbytes of storage may be required. If the available space in cache is insufficient to store all of the required frames, then it becomes necessary to implement a drop and fetch strategy to store in cache only a portion of the frames at any one time.

As another example, approximately 7.3 Gbytes of storage may be required to store 14,500 frames (approximately 0.5 Mbytes each) of three-dimensional computed tomography (also known as CT or CAT). While CT's are typically not played in full as a moving image, moving back and forth between two points in the three-dimensional image may again make it necessary to render many high-resolution frames in succession at a high rate. This requires significantly more processing power and memory capacity than typical consumer video applications such as DVD playback or playback of compressed streaming video.

While the cost of cache memory has fallen over time, the storage capacity required to store hundreds or even thousands of large data frames may make it impractical or quite impossible to store everything in cache. Thus, a more efficient method and system for caching and fetching data is desirable.

### SUMMARY

The present invention relates to a system and method for fetching a plurality of data frames for processing in succession at a desired rate. Data frames are fetched into available space in cache. A priority level is then assigned to each data frame by applying a recurring priority level pattern. A suitable priority level cut-off may be selected based on at least one of the desired rate of processing, the size of the data frames, and the available space in cache. Any data frames with a priority level below the priority level cut-off are dropped. Successive data frames having assigned priority levels above the priority level cut-off are selectively fetched into cache.

In an aspect of the invention, there is provided a data processing system implemented method of fetching a plurality of data frames for processing in succession at a desired rate, comprising: fetching the plurality of data frames into available space in cache; assigning a priority level to each of the plurality of data frames by applying a recurring priority level pattern; selecting a priority level cut-off for the plurality of data frames.

In an embodiment, the data processing system implemented method further comprises dropping from the cache any data frames with a priority level below the priority level cut-off.

In another embodiment, the data processing system implemented method further comprises selectively fetching into the cache any successive data frames with a priority level above the priority level cut-off.

In another embodiment, the data processing system implemented method further comprises selecting the priority level cut-off in dependence upon at least one of the desired rate, the size of the plurality of data frames, and the available space in the cache.

In another embodiment, the data processing system implemented method further comprises applying different priority levels to adjacent data frames utilizing the recurring priority level pattern.

In another embodiment, the data processing system implemented method further comprises applying a different priority level to each data frame within a recurring cycle utilizing the recurring priority level pattern.

In another embodiment, the data processing system implemented method further comprises applying an alternating saw-tooth arrangement utilizing the recurring priority level pattern.

In another embodiment, the data processing system implemented method further comprises setting the length of the recurring priority level pattern to be at least two data frames in length.

In another embodiment, the plurality of data frames comprise digital image frames, and the processing comprises rendering the image frames for display in succession at the desired rate.

In another aspect of the invention, there is provided a data processing system for fetching a plurality of data frames for processing in succession at a desired rate, comprising: a cache for fetching into available space the plurality of data frames; an assignment module for assigning a priority level to each of the plurality of data frames by applying a recurring priority level pattern; a selection module for selecting a priority level cut-off for the plurality of data frames.

In an embodiment, the data processing system further comprises a drop module for dropping from the cache any data frames with a priority level below the priority level cut-off.

In another embodiment, the data processing system further comprises a fetch module for selectively fetching into the cache any successive data frames with a priority level above the priority level cut-off.

In another embodiment, the selection module is configurable to select the priority level cut-off in dependence upon at least one of the desired rate, the size of the plurality of data frames, and the available space in the cache.

In another embodiment, the recurring priority level pattern applies different priority levels to adjacent data frames.

In another embodiment, the recurring priority level pattern applies a different priority level to each data frame within a recurring cycle.

In another embodiment, the recurring priority level pattern is at least two data frames in length.

In another embodiment, the plurality of data frames comprise digital image frames, and the processing comprises rendering the image frames for display in succession at the desired rate.

In another aspect of the invention, there is provided a program product operable on a data processing system, the program product comprising: a data processing system usable medium; wherein the data processing system usable medium includes instructions for fetching a plurality of data frames for processing in succession at a desired rate, comprising: instructions for fetching the plurality of data frames into available space in cache; instructions for assigning a priority level to each of the plurality of data frames by applying a recurring priority level pattern; instructions for selecting a priority level cut-off for the plurality of data frames.

In an embodiment, the instructions for fetching a plurality of data frames for processing in succession at a desired rate, further comprises instructions for dropping from the cache any data frames with a priority level below the priority level cut-off.

In another embodiment, the instructions for fetching a plurality of data frames for processing in succession at a desired rate, further comprises instructions for selectively fetching into the cache any successive data frames with a priority level above the priority level cut-off.

In another embodiment, the instructions for fetching a plurality of data frames for processing in succession at a desired rate, further comprises instructions for selecting the priority level cut-off in dependence upon at least one of the desired rate, the size of the plurality of data frames, and the available space in the cache.

These and other aspects of the invention will become apparent from the following more particular descriptions of exemplary embodiments.

### BRIEF DESCRIPTION OF THE DRAWINGS

In the figures which illustrate exemplary embodiments of the invention:

FIG. 1 shows a schematic block diagram of a data processing system which may provide an operating environment for practicing exemplary embodiments of the invention;

FIG. 2 shows a schematic block diagram of an exemplary architecture suitable for practicing exemplary embodiments of the invention;

FIGS. 3A to 3F show a series of x-y graphs illustrating a recurring priority level pattern, and selection of a suitable cut-off, in accordance with an embodiment of the invention;

FIG. 4 shows a schematic flow chart of a method in accordance with an embodiment of the invention, corresponding to the illustrative example shown in FIGS. 3A to 3F.

### DETAILED DESCRIPTION

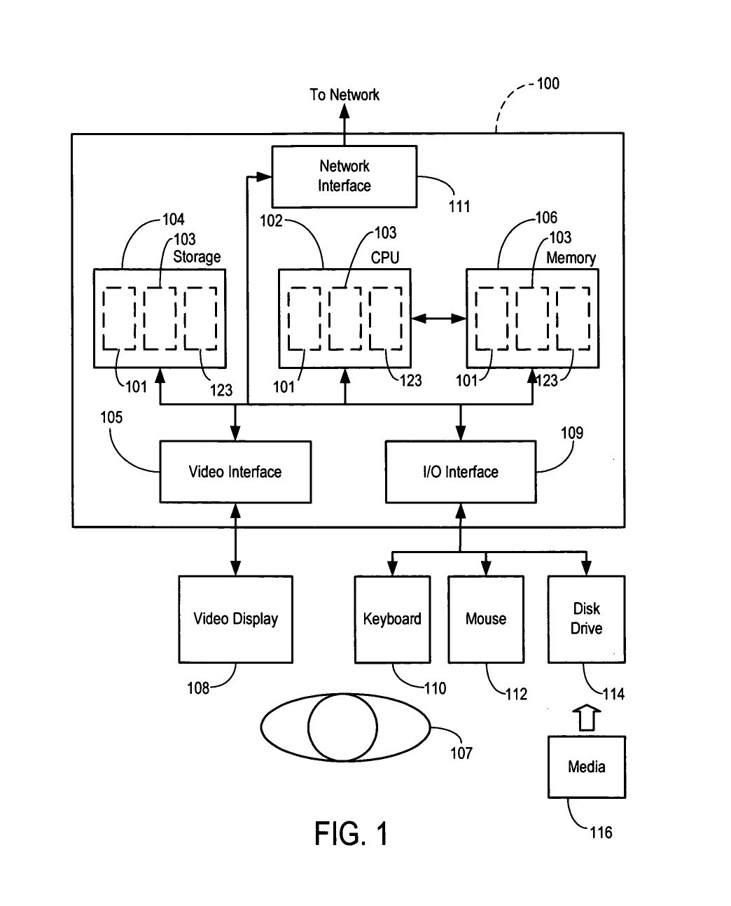

FIG. 1 shows a schematic block diagram of a data processing system which may provide an operating environment for practicing exemplary embodiments of the invention. The data processing system 100 may include a central processing unit (“CPU”) 102 connected to a storage unit 104 and to a random access memory 106. The CPU 102 may process an operating system 101, application software 103, and data 123. The operating system 101, application software 103, and data 123 may be stored in storage unit 104 and loaded into memory 106, as required. A user 107 may interact with the data processing system 100 using a video display 108 connected by a video interface 105, and various input/output devices such as a keyboard 110, mouse 112, and disk drive 114 connected by an I/O interface 109. In known manner, the mouse 112 may be configured to control movement of a cursor in the video display 108, and to operate various graphical user interface (“GUI”) controls appearing in the video display 108 with a mouse button. The disk drive 114 may be configured to accept data processing system usable media 116. The data processing system 100 may be network enabled via a network interface 111, allowing the data processing system 100 to communicate with other compatible data processing systems across a network (not shown).

It will be appreciated that the data processing system 100 illustrated in FIG. 1 is merely illustrative, and is not meant to be limiting in terms of the type of system that may provide a suitable operating environment for practicing various embodiments of the present invention.

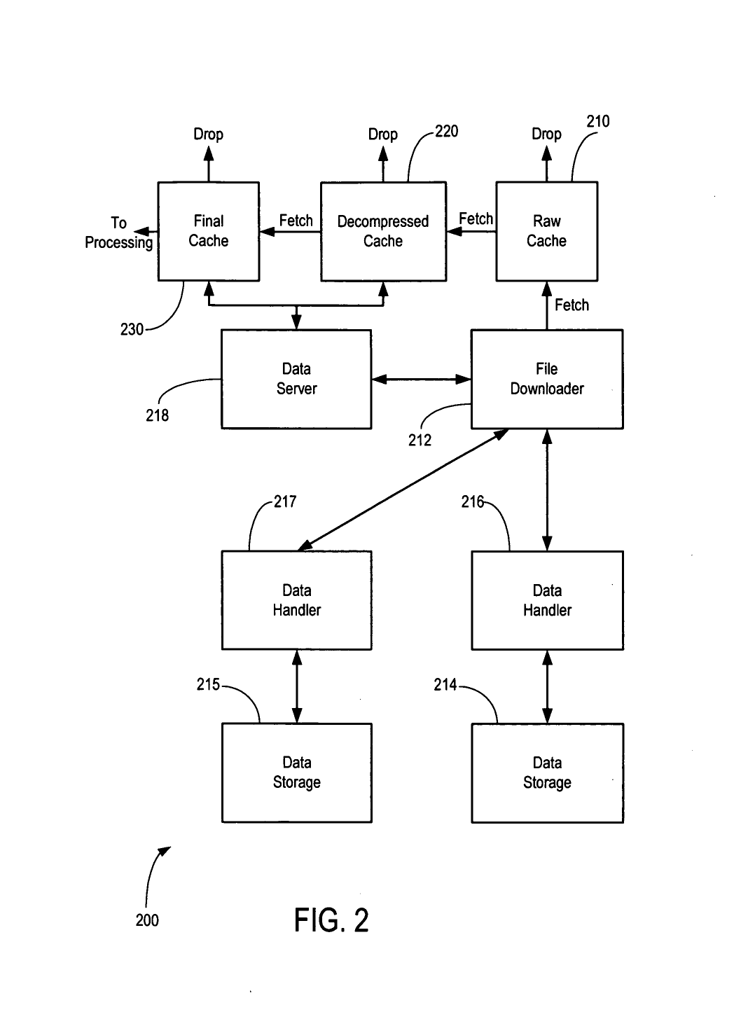

FIG. 2 shows a schematic block diagram of an exemplary architecture 200 suitable for practicing exemplary embodiments of the invention. In this illustrative example, there are three levels of cache. By way of example, these three levels of cache may be embodied in memory 106 of FIG. 1. Alternatively, these three levels of cache may be embodied in separate memory operatively connected to CPU 102 of FIG. 1.

Although three levels of cache are illustrated in FIG. 2, this is not meant to limit the scope of the claimed invention in any way. The invention may be practiced with any suitable cache architecture. For example, the cache architecture may comprise a single level of cache with data fetched from large capacity storage. Alternatively, a multi-level cache architecture may be used where data may be fetched into cache more quickly from other levels of cache. Each of the three levels of cache in this illustrative example is now described in more detail.

First, a “raw” cache 210 may store raw data downloaded by file downloader module 212 from data storage 214, 215. Data storage 214, 215 may be handled by data handler modules 216, 217, respectively. Data storage 214, 215 may be embodied in storage 104 of FIG. 1. Alternatively, data storage 214, 215 may be connected on a network accessible via network adapter 111. The data obtained from data storage 214, 215 and stored in raw cache 210 may be typically in a compressed form (e.g. compressed image frames using the Joint Photographic Experts Group or “JPEG” standard). Raw cache 210 may have a relatively high capacity to store raw, compressed data.

Second, a “decompressed” cache 220, configured with a suitable background calculator thread, may store decompressed data (e.g. decompressed image frames) received from raw cache 210. As data in decompressed cache 220 is not compressed, the decompressed cache 220 may not hold as much data as raw cache 210. However, access to the decompressed data in decompressed cache 220 will be relatively fast.

Third, a “final” cache 230 may store the actual data (e.g. image frames) required for processing (e.g. by CPU 102). The final cache 230 may also store data that may be altered in some way (e.g. image frame scaling, sharpening, etc.).

A data server module 218 may be used to control fetching of data from raw cache 210, into decompressed cache 220, and then to final cache 230. In this example, the final cache 230 holds the data that will be finally processed (e.g. rendered for display in video display 108 of FIG. 1). Data server module 218 may be embodied, for example, as application software 103 in data processing system 100 of FIG. 1.

Raw cache 210 and the decompressed cache 220 may be used to feed data to the final cache 230 when a cache miss occurs in the final cache 230. When there is a miss on all the caches 210, 220, 230, data may be obtained from data storage 214, 215, for example.

Raw cache 210 and decompressed cache 220 may also have a fetching scheme, although they may be different from that of the present invention. For example, they could rely on a simple first-in-first-out (FIFO) scheme to determine which data frames to cache. Accessing a data frame from one of the raw cache 210 and the decompressed cache 220 may reset the data frame position to be most recent (and therefore removed later).

By using a forward looking, selective fetching scheme in the final cache 230, it is expected that cache misses in the final cache 230 may be fulfilled in most cases by fetching data from one of the other two caches 210, 220.

An illustrative example of a system for caching and fetching data will now be described in detail.

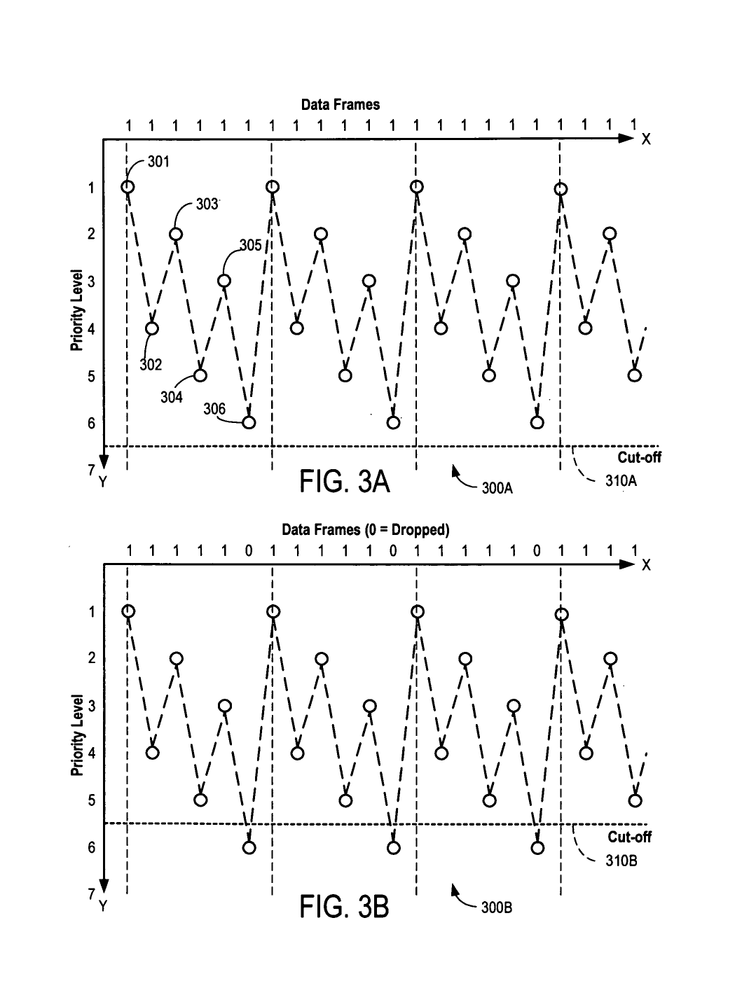

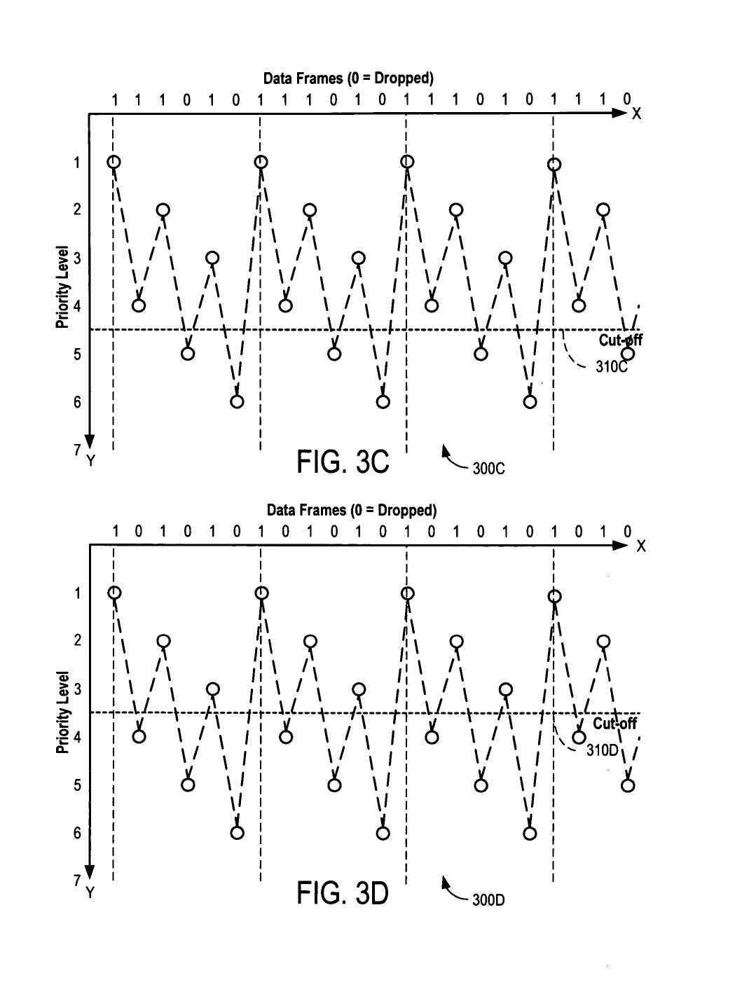

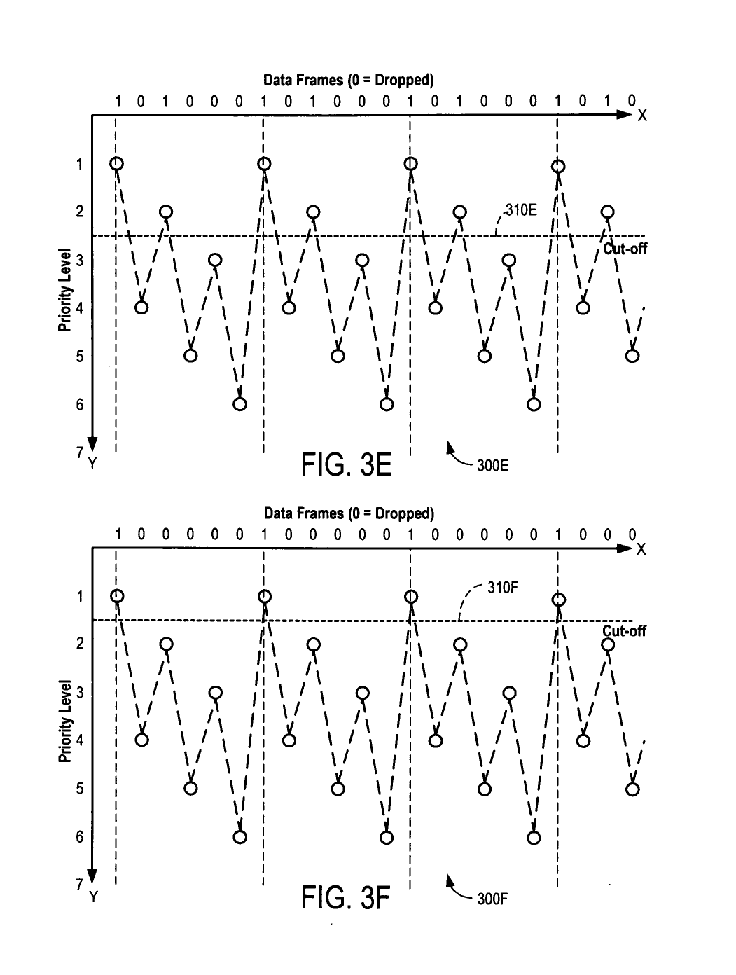

In an embodiment, the system for caching and fetching data may comprise a number of modules, embodied for example in data processing system 100 generally and in application software 103. More specifically, the system for caching and fetching data may include an assignment module for assigning a priority level to each of a plurality of data frames by applying a recurring priority level pattern. By way of example, FIGS. 3A to 3F show a series of x-y graphs illustrating a possible recurring priority level pattern. The system may further include a selection module for selecting a priority level cut-off for the plurality of data frames. Selection of a suitable cut-off utilizing such a selection module is also illustrated in FIGS. 3A to 3F.

As shown in FIG. 3A, a successive series of data frames are represented as a series of 1's along the x-axis of x-y graph 300A. Priority levels from 1 to 7 are indicated along the inverted y-axis of x-y graph 300A. As shown in x-y graph 300A, a plurality of dots 301 to 306 indicate various priority levels assigned to each data frame along the x-axis. (It will be appreciated that the dashed lines connecting the dots are shown merely to emphasize the recurring pattern.) For example, starting from the leftmost data frame on the x-axis, and reading to the right, a recurring priority level pattern assigns to the first six data frames the following priority levels: 1, 4, 2, 5, 3 and 6, respectively. As will be seen, the recurring priority level pattern 1, 4, 2, 5, 3 and 6 repeats itself, beginning at the 7^{th} data frame, and again at the 13^{th} and the 19^{th} data frames. (Note, however, that this recurring priority level pattern is not meant to be limiting, and that other suitable recurring priority level patterns may be used.)

As will now be explained, by applying a suitable cut-off level against the recurring priority level pattern, a deterministic scheme for dropping data frames and selectively fetching other data frames into cache is created.

Still referring to FIG. 3A, in the x-y graph 300A, a horizontal stippled line 310A labelled “cut-off” is shown below priority level 6. In this case, all of the data frames have an assigned priority level above the cut-off. Thus, FIG. 3A may represent a situation where there is sufficient space available in cache to store all necessary data frames (i.e. no data frames need to be dropped).

Now referring to FIG. 3B, x-y graph 300B has the same recurring priority level pattern as shown in x-y graph 300A of FIG. 3A. However, the cut-off 310B is now set above priority level 6 and below priority level 5. As will be seen, three of the data frames shown in x-y graph 300B have an assigned priority level of 6, which falls below the cut-off. Consequently, in this case, the three data frames are dropped from cache, as indicated in this illustrative example by the use of “0” in place of “1” along the x-axis of x-y graph 300B. For this purpose, a suitably configured drop module (e.g. as embodied in data processing system 100 and application software 103) may be provided to test whether each assigned priority level is below the selected cut-off.

Now referring to FIG. 3C, x-y graph 300C has the same recurring priority level pattern as shown in x-y graph 300A of FIG. 3A, and as shown in x-y graph 300B of FIG. 3B. However, the cut-off 310C is now set above priority level 5, and below priority level 4. Now, it will be seen that seven of the data frames shown have an assigned priority level of 5 or 6, which fall below the cut-off. Consequently, in this case, seven data frames are dropped from cache, as again indicated by the use of “0” in place of “1” along the x-axis of x-y graph 300C.

In an analogous fashion, FIGS. 3D to 3F show x-y graphs 300D, 300E and 300F with cut-offs 310D, 310D and 310F, respectively, that are set progressively higher. Thus, as shown in FIG. 3F, for example, only four data frames now have assigned priority levels above the cut-off 310F. The remainder of the frames are dropped from cache. This may be a situation where the cache is rather small, or where the desired rate of processing is very high.

In an illustrative embodiment, the cut-off (i.e. one of 310A to 310F) may be set based on at least one of the desired rate of processing, the size of the plurality of data frames, and the amount of space that is available in cache. For example, if the desired rate of processing increases, then the cut-off may need to be set higher to drop additional frames in order to compensate for the increased demand for cache storage. As another example, if most of the required data frames have been fetched into cache, it may only be necessary to set a relatively low cut-off, as shown in FIG. 3B. In this case, only a few data frames need to be dropped from cache. If there is a more significant shortage of space in cache, a higher cut-off may be set (as in FIG. 3C or FIG. 3D for example) so that more of the lower priority data frames may be dropped from cache.

Once the cut-off has been set, as the priority level pattern is recurring, it will be appreciated that it is now possible to identify in advance which successive data frames must be fetched into cache. A suitably configured fetch module (e.g. as embodied in data processing system 100 and application software 103) may be used to selectively fetch only those data frames that are above the cut-off.

Preferably, the selective fetching of successive data frames into cache should look forward at least the length of the recurring priority level pattern, or longer, so that any data frames required for processing in the next recurring cycle may be selectively fetched into cache at a sufficient rate to maintain the desired processing rate.

Advantageously, by creating a completely deterministic scheme for dropping data frames, and selectively fetching successive data frames into cache, the data processing overhead required to handle dropping and fetching may be significantly reduced. This is because it is no longer necessary to expend processing resources to decide, at each moment, which data frames should be dropped and which data frames should be selectively fetched into cache. By using a suitable recurring priority level pattern, and by applying a suitable cut-off level, the dropping and fetching scheme may be set deterministically with no further decision making required during the duration of processing a particular set of successive data frames. If some parameters change, another suitable cut-off level may be selected, and the dropping and fetching scheme may again be set.

In the context of digital medical imaging applications, this dropping and fetching scheme may result in reduced cache misses (i.e. a required image frame is missing), such that smoother playback is achieved when rendering successive high-resolution image frames at a desired rate.

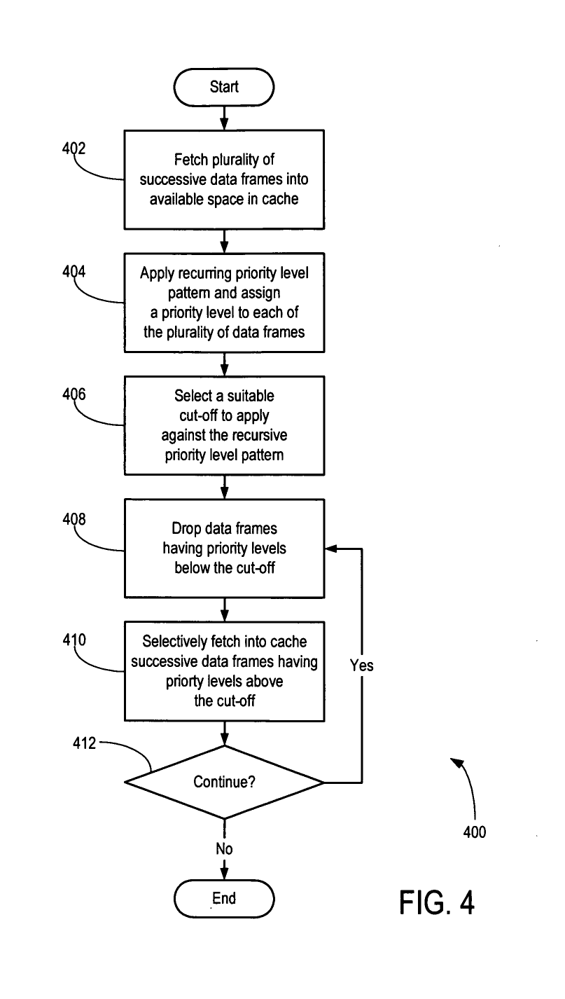

FIG. 4 shows a schematic flow chart of an illustrative method 400 in accordance with an embodiment of the invention. Method 400 generally corresponds to the illustrative embodiment shown and discussed above with reference to FIGS. 3A to 3F. Method 400 begins and proceeds to block 402, where method 400 fetches a plurality of data frames into available space in cache. From block 402, method 400 proceeds to block 404, where a recurring priority level pattern is applied to assign a priority level to each of the data frames. Method 400 then proceeds to block 406, where method 400 selects a suitable priority level cut-off to apply against the recurring priority level pattern.

Referring back to FIG. 4, at block 408, method 400 drops those data frames having priority levels below the cut-off. Method 400 then proceeds to block 410, where method 400 selectively fetches into cache successive data frames having priority levels above the cut-off.

Method 400 then proceeds to decision block 412, where method 400 may either return to block 408 to continue the dropping and selective fetching data frames, or else proceed to End.

While illustrative embodiments of the invention have been described above, it will be appreciated by those skilled in the art that variations and modifications may be made. For example, the recurring priority level pattern has a length of 6 frames, and a range of priority levels between 1 and 6. However, another recurring priority level pattern may be used. For example, the recurring priority level pattern may have a different length (i.e. number of frames), and have a wider or narrower range of priority levels. In the context of processing image frames, while the recurring priority level pattern may have a length of at least two, a more preferred length may be between four and thirty. The recurring priority level pattern may have the alternating “saw-tooth” arrangement shown in the illustration (FIGS; 3A to 3F), or may have another pattern that may result in a desired dropping and fetching scheme. Also, while a specific example has been discussed in relation to digital medical imaging, it will be appreciated that the teachings of the present invention may be applicable to other applications in which a more efficient caching and fetching scheme is desired. Thus, the scope of the invention is defined by the following claims.

What is claimed is:

1. A data processing system implemented method of fetching a plurality of data frames for processing in succession at a desired rate, comprising:
fetching said plurality of data frames into available space in cache;
assigning a priority level to each of said plurality of data frames by applying a recurring priority level pattern;
selecting a priority level cut-off for said plurality of data frames.

2. The data processing system implemented method of claim 1, further comprising dropping from said cache any data frames with a priority level below said priority level cut-off.

3. The data processing system implemented method of claim 2, further comprising selectively fetching into said cache any successive data frames with a priority level above said priority level cut-off.

4. The data processing system implemented method of claim 1, further comprising selecting said priority level cut-off in dependence upon at least one of said desired rate, the size of said plurality of data frames, and the available space in said cache.

5. The data processing system implemented method of claim 1, further comprising applying different priority levels to adjacent data frames utilizing said recurring priority level pattern.

6. The data processing system implemented method of claim 1, further comprising applying a different priority level to each data frame within a recurring cycle utilizing said recurring priority level pattern.

7. The data processing system implemented method of claim 6, further comprising applying an alternating saw-tooth arrangement utilizing said recurring priority level pattern.

8. The data processing system implemented method of claim 1, further comprising setting the length of said recurring priority level pattern to be at least two data frames in length.

9. The data processing system implemented method of claim 1, wherein said plurality of data frames comprise digital image frames, and said processing comprises rendering said image frames for display in succession at said desired rate.

10. The data processing system implemented method of claim 9, further comprising dropping from said cache any image frames with a priority level below said priority level cut-off.

11. The data processing system implemented method of claim 10, further comprising selectively fetching into said cache any successive image frames with a priority level above said priority level cut-off.

12. The data processing system implemented method of claim 9, further comprising selecting said priority level cut-off in dependence upon at least one of said desired rate, the size of said plurality of image frames, and the available space in said cache.

13. The data processing system implemented method of claim 9, further comprising applying different priority levels to adjacent image frames utilizing said recurring priority level pattern.

14. The data processing system implemented method of claim 9, further comprising applying a different priority level to each image frame within a recurring cycle utilizing said recurring priority level pattern.

15. The data processing system implemented method of claim 9, wherein said recurring priority level pattern is at least two image frames in length.

16. The data processing system implemented method of claim 9, wherein said recurring priority level pattern is between four image frames and thirty image frames in length.

17. A data processing system for fetching a plurality of data frames for processing in succession at a desired rate, comprising:
a cache for fetching into available space said plurality of data frames;
an assignment module for assigning a priority level to each of said plurality of data frames by applying a recurring priority level pattern;
a selection module for selecting a priority level cut-off for said plurality of data frames.

18. The data processing system of claim 17, further comprising a drop module for dropping from said cache any data frames with a priority level below said priority level cut-off.

19. The data processing system of claim 18, further comprising a fetch module for selectively fetching into said cache any successive data frames with a priority level above said priority level cut-off.

20. The data processing system of claim 17, wherein said selection module is configurable to select said priority level cut-off in dependence upon at least one of said desired rate, the size of said plurality of data frames, and the available space in said cache.

21. The data processing system of claim 17, wherein said recurring priority level pattern applies different priority levels to adjacent data frames.

22. The data processing system of claim 17, wherein said recurring priority level pattern applies a different priority level to each data frame within a recurring cycle.

23. The data processing system of claim 17, wherein said recurring priority level pattern is at least two data frames in length.

24. The data processing system of claim 17, wherein said plurality of data frames comprise digital image frames, and said processing comprises rendering said image frames for display in succession at said desired rate.

25. A program product operable on a data processing system, said program product comprising: a data processing system usable medium; wherein said data processing system usable medium includes instructions for fetching a plurality of data frames for processing in succession at a desired rate, comprising:
instructions for fetching said plurality of data frames into available space in cache;
instructions for assigning a priority level to each of said plurality of data frames by applying a recurring priority level pattern;
instructions for selecting a priority level cut-off for said plurality of data frames.

26. The program product of claim 25, wherein said instructions for fetching a plurality of data frames for processing in succession at a desired rate further comprises instructions for dropping from said cache any data frames with a priority level below said priority level cut-off.

27. The program product of claim 25, wherein said instructions for fetching a plurality of data frames for processing in succession at a desired rate further comprises instructions for selectively fetching into said cache any successive data frames with a priority level above said priority level cut-off.

28. The program product of claim 25, wherein said instructions for fetching a plurality of data frames for processing in succession at a desired rate further comprises instructions for selecting said priority level cut-off in dependence upon at least one of said desired rate, the size of said plurality of data frames, and the available space in said cache.
